(19) United States
(12) Patent Application Publication
(10) Pub. No.: US 2010/0328428 A1
(43) Pub. Date: Dec. 30, 2010

(54) Optimized stereoscopic visualization

(76) Inventors: Lawrence A. Booth, JR., Phoenix, AZ (US); George Chen, Los Gatos, CA (US)

Correspondence Address: TROP, PRUNER & HU, P.C., 1616 S. VOSS RD., SUITE 750, HOUSTON, TX, 77057-2631, US

(21) Appl. No.: 12/459,099

(22) Filed: Jun. 26, 2009

(51) Int. Cl. H04N 13/02; G06T 15/00

(52) U.S. Cl. 348/46; 345/419; 348/E13.074

(57) ABSTRACT

The present invention discloses a method comprising: calculating an X separation distance between a left eye and a right eye, said X separation distance corresponding to an interpupilary distance in a horizontal direction; and transforming geometry and texture only once for said left eye and said right eye.

### BACKGROUND OF THE INVENTION

1. Field of the Invention

The present invention relates to a field of graphics processing and, more specifically, to an apparatus for and a method of optimized stereoscopic visualization.

2. Discussion of Related Art

Left and right eye views for a scene are processed independently thus doubling the processing time. As a result, generation of left and right eye views for stereoscopic display is usually not very efficient. In particular, the conventional procedure results in lower performance and higher power consumption. The disadvantages become particularly difficult to overcome for a mobile device.

Thus, a new solution is required to improve efficiency of graphics processing for stereoscopic display especially for the mobile device.

### BRIEF DESCRIPTION OF THE DRAWINGS

FIG. 1 shows a combined viewport frustum according to an embodiment of the present invention.

FIGS. 2-5 show a flowchart for integrated left/right eye view generation according to various embodiments of the present invention.

### DETAILED DESCRIPTION OF THE PRESENT INVENTION

In the following description, numerous details, examples, and embodiments are set forth to provide a thorough understanding of the present invention. However, it will become clear and apparent to one of ordinary skill in the art that the invention is not limited to the details, examples, and embodiments set forth and that the invention may be practiced without some of the particular details, examples, and embodiments that are described. In other instances, one of ordinary skill in the art will further realize that certain details, examples, and embodiments that may be well-known have not been specifically described so as to avoid obscuring the present invention.

The present invention relates to an apparatus for and a method of optimized stereoscopic visualization for graphics processing. An Application Programming Interface (API) includes software, such as in a programming language, to specify object classes, data structures, routines, and protocols in libraries that may be used to help build similar applications.

The A.P.I. to generate a three-dimensional (3D) scene in a two-dimensional (2D) view includes a procedure to represent, manipulate, and display models of objects. First, texture, map, and geometry data are specified in a general flow. Processing for game logic and artificial intelligence will follow. Next, processing for other tasks, including physics, animation, and collision detection, is performed.

A manifold is a composite object that is drawn by assembling simpler elements from lists of vertices, normal vectors (normals), edges, faces, or primitives. The primitives may be linear, such as line segments, or planar, such as polygons, or 3-dimensional, such as polyhedrons. A triangle is frequently used,as a primitive since three points are always located in a plane.

Using a primitive with a more complex shape than a triangle may provide a tighter fit to a boundary of a shape or to a surface of a structure. However, checking for any overlap between primitives becomes more complex. An orientable two-manifold includes two properties: all points on the surface locally define a plane and the plane does not have any opening, gap, or self-intersection.

Useful models having generalized shapes may be defined and imported by various software tools to allow a desired graphical scene to be created more efficiently. The standard templates in a set that is supported by the software tools may be altered and extended to implement other related objects which possess a certain size, orientation, and position in the graphical scene.

A composite geometry transformation includes application of operations to general object models to build more complex graphical objects. The operations may include scaling, rotation, and translation, in this order. Scaling changes the coordinates of an object in space by multiplying by a fixed value to alter a size of the object. Rotation changes the coordinates of the object in space relative to a certain reference point, such as an origin, to turn the object through a particular angle. Translation changes the coordinates of the object in space by adding a fixed value to shift the object a certain distance. In an ordered sequence of transformations, a function that is specified last will be applied first.

The discrete integer coordinates of the vertices of the object are determined in 3D space. The coordinates are specified in an ordered sequence. For computational purposes, a transformation is implemented by multiplying the vertices of the model by a transformation matrix. The transformation may be controlled by parameters that change with passage of time. The direction towards which a face of an object is oriented may be defined by a normal vector (normal) relative to a coordinate system.

A process is managed by defining the transformation, making a copy of a current version to save a state of the transformation, pushing the copy onto a stack, applying subsequent transformations to the copy at the top of the stack, and, as needed, popping the stack, discarding the copy that was removed, returning to an original transformation state, and beginning to work again at that point. Thus, various simple parts may be defined and then combined and assembled in standard ways to use them to create other composite objects.

Geometrical compression techniques may be used. Such approaches improve efficiency since information that has already been generated may be retained by the system and reused in rendering instead of being regenerated again. Line strips, triangle strips, triangle fans, and quad strips are frequently used to improve efficiency.

The various objects that make up the graphical scene are then organized. The data and data types that describe the objects are placed into a unified data structure called a scene graph. The scene graph captures and holds the appropriate transformations and object-to-object relationships in a tree or a directed acyclic graph (DAG). Directed means that the parent-child relationship is one-way. Acyclic means that loops are not permitted although graphics engines are now often capable of performing looped procedures.

A geometric mesh of the 3D scene is subsequently stored in a cache. Then, the data generated for the scene are usually transferred from the 3D graphics application to a hardware (HW) graphics engine for further processing. Depending on an implementation that is specified, some of the processes may be performed in a different order. Certain process steps may even be eliminated. However, most implementations will include two major portions of processing. The first portion includes geometry processing. The second portion includes pixel (or fragment) processing.

First, the hardware graphics processing takes the geometric mesh and performs a geometry transform on the boundary points or vertices to change coordinate systems. Then, the vertices of each object are mapped to appropriate locations in a 3D world.

Mapping of the objects in the 3D world is followed by vertex lighting calculations. Vertices in the graphical scene are shaded according to a lighting model to convey shape cues. The physics and optics of surface illumination are simulated. The position, direction, and shape of light sources are considered and evaluated.

An empirical Phong lighting model may be used. Diffuse lighting is simulated according to Lambert's Law while specular lighting is simulated according to Snell's law. In one case, bulk optical properties of the material forming the objects attenuate incident light. In another case, microstructures located at or near the surface of the objects affect a spectrum of reflected light and emitted light to produce a color perceived by a viewer.

Culling discards all portions of the objects and the primitives in the graphical scene that are not visible from a chosen viewpoint. The culling simplifies rasterization and improves performance of rendering, especially for a large model.

In one instance, view frustum culling (VFC), or face clipping, removes portions of the objects that are located outside of a defined field of view (FOV), such as a frustum which is a truncated pyramid.

A polygon against a line may be clipped. The edges of the polygon that are located entirely inside the line are retained. Other edges of the polygon that are located entirely outside the line are removed. A new point and a new edge are created upon entry into the polygon. A new point is created upon exit from the polygon.

More generally, clipping is done against a convex region. The convex region is a union of negative half-spaces. Clipping is done against one edge at a time to create cut-away views of a model.

To improve efficiency, a bounding volume hierarchy (BVH) subdivides a view volume into cells, such as spheres or bounding boxes. A binary space partition (BSP) tree includes planes that recursively divide space into half-spaces. The BSP-tree creates a binary tree to provide a depth order of the objects in the view volume. The bounding volume -hierarchies accelerate culling by combining primitives together and rejecting or accepting entire sub-trees at a time.

In another instance, back-face culling removes portions of the objects whose surface normal vectors (normals) face away from the chosen viewpoint since the backside of the objects are not visible to the viewer. A back-face has a clockwise vertex ordering when viewed from outside the objects. Back-face culling may be applied to any orientable two-manifold to remove a subset of the primitives. The back-face culling is done in a set-up phase of rasterization.

A closed object is an object that has well-defined inside and outside regions. Convex self-occlusion is a special case where some portions of the closed object are blocked by other portions of the same object that are located closer to the viewer (farther in front of the scene).

In still another instance, portions of objects may be occluded by portions of other objects that are located closer to the viewer (farther in front of the scene). Occlusion culling removes portions of objects that do not contribute to a final view because they are located behind portions of opaque objects as seen from the chosen viewpoint.

The visible parts of a model for different views are called potentially visible sets (PVSs). Complexity of the occlusion detection may be reduced by using preprocessing. The occlusion culling may be performed on-line, such as during visualization, or off-line, such as before visualization.

Stereoscopic visualization is a perception of 3D that depends on a generation of separate left and right eye views, such as in a display. The orthogonal world coordinate space is geometrically transformed into a perspective-corrected eye view that depends on position and orientation of various objects relative to the viewer. The result is a 2D representation of the 3D scene.

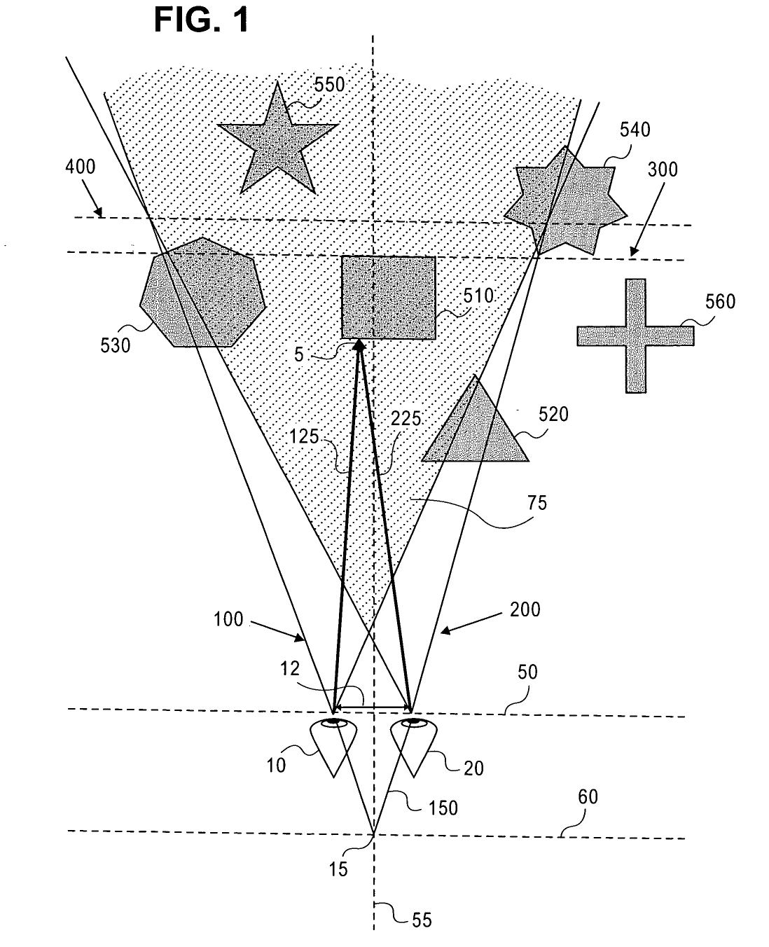

In an embodiment of the present invention as shown in FIG. 1, a left eye 10 and a right eye 20 in a head of a viewer are located at a baseline 50. The left eye 10 and the right eye 20 straddle a central axis 55 symmetrically.

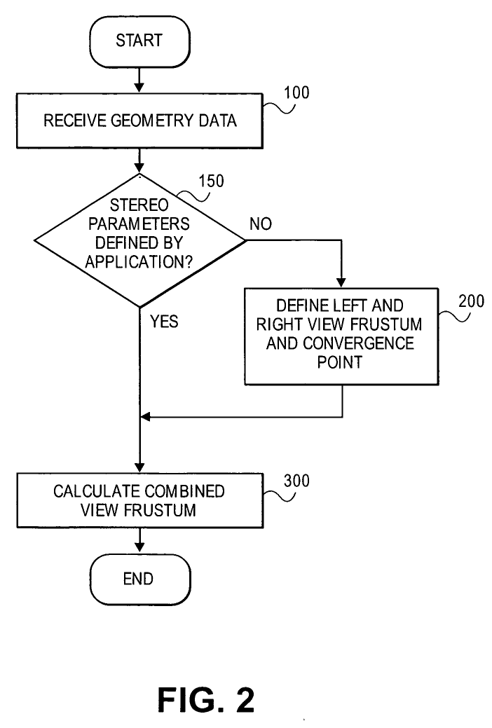

FIGS. 2-5 show a flowchart for a method of generating integrated left/right eye view according to various embodiments of the present invention. As shown in block 100, geometric data are first received.

Next, a query is made a block 150 as to whether stereo parameters are defined by the application.

If a response to the query in block 150 in FIG. 2 is negative, in other words, the stereo parameters are not yet defined by the application, then it is necessary to first define a left viewport frustum, a right viewport frustum, and a convergence point in block 200 before a combined viewport frustum is calculated next in block 300.

As shown in FIG. 1, a left viewport frustum 100 corresponds to a projection for the left eye 10 while a right viewport frustum 200 corresponds to a projection for the right eye 20. The left viewport frustum 100 and the right viewport frustum 200 overlap and form a stereoscopic region 75.

In one situation as shown in FIG. 1, the two projections 100, 200 subtend equal angles. In another situation, the two projections 100, 200 subtend different angles.

A convergence, or fixation, point, 5 is a location infront of the eyes where the two viewing distances 125, 225 intersect. In one situation as shown in FIG. 1, the two projections are off-axis. In another situation, the two projections are on-axis.

If the convergence point 5 is chosen along the central axis 55 and at a small distance, such as Z parameter, from the baseline 50, then the two view frustums 100, 200 will appear toe-in.

However, if the convergence point is chosen along the central axis 55 but at a very large distance, such as Z parameter, from the baseline 50, then the two viewing distances 125, 225 are essentially considered to be infinite and parallel. In other words, the two eyes 10, 20 are assumed to be tracking straight forward. In such a case, a field of view is changed by moving the head either towards the left side or towards the right side of the central axis 55.

A visual field for the viewer results from linking the left viewport frustum 100 and the right viewport frustum 200. The resultant visual field typically extends through a total of 200 degrees horizontally. The central portion of the visual field includes the stereoscopic region 75, also known as the binocular overlap region 75. The stereoscopic region 75 typically extends through 120 degrees.

The geometric transformation to each of the two viewport frustums 100, 200 also results in a foreshortening in which nearby objects in the scene appear larger while distant objects appear smaller. Presented with depth cues such as foreshortening, the viewer mentally fuses the two images in the seteoscopic region 75 (stereo fusion) to perceive a 3D scene.

The geometric transformation also depends on intrinsic parameters, such as resolution of a retina in a human eye and aspect ratio of the object being viewed. Resolution for the human viewer encompasses 0.3-0.7 arc minutes, depending on a luminance of the objects being viewed as well as depending on a particular visual task being performed. The resolution for the human viewer extends down to 0.1-0.3 arc minute for tasks that involve resolving verniers.

Temporal resolution becomes important for an object that only appears in the field of view for a very short time. Temporal resolution is also important for an object that moves extremely quickly across the field of view. The temporal resolution for the human viewer is about 50 Hz. The temporal resolution increases with the luminance of the objects being viewed.

Many methods may be used to provide separate views to the left eye 10 and the right eye 20 of the viewer. A conventional procedure requires that a full geometry be processed two times through an earlier stage of geometry acceleration, as well as, through a subsequent stage of 3D pixel rendering. Unfortunately, the processing workload and bandwidth (BW) would be doubled for input of the geometry, for intermediate parameter storage, Z parameter buffer, stencil buffer, and for the textures.

Consequently, in an embodiment of the present invention, vertex processing for the left eye view and vertex processing for the right eye view are integrated. This may be accomplished since the two eyes 10, 20 of the viewer maintain a relationship with each other that includes a constant X separation distance between vertices transformed for a left eye 10 and a right eye 20 at the baseline 50 where the two eyes are located. Consequently, the 3D views also follow the same fixed eye constraints.

The geometry coordinates produced by the left and right eye views differ only at the baseline 50, such as in a Horizontal direction. In an optimization method as shown in FIG. 1, only a term for the additional X separation distance is required. This may be accomplished in several ways. In one case, an additional vector calculation is performed in a subsequent step. In another case, a 5×4 matrix transform is performed by a matrix transform engine.

Furthermore, when the two parameters of X-coordinates (horizontal components) are calculated at the same time according to the present invention, the orthogonal world coordinate input data required for both calculations are already in the computation pipeline. Thus, the data do not have to be re-read from either an external memory or a local cache.

In another optimization method, if a Z distance is beyond a maximum disparity distance 400 as shown in FIG. 1, the left and right eye views do not require separate object representations. Thus, the additional X separation distance 12 representation is bypassed and the same X value is stored for both the left eye 10 and the right eye 20.

The maximum disparity distance 400 is a function of vernier visual acuity and resolution as well as viewing distance from the left eye 10 and the right eye 20 to the display. A neurological mechanism used by a human eye to operate on disparity information to converge, focus, and determine Z distance and 3D shape will operate at vernier, resolution.

An interpupilary distance 12 of about 6.5 cm along the baseline 50 results in a maximum stereoscopic range of about 670 m. For vernier resolution tasks, the stereoscopic range is larger, such as about 1,000 m.

However, if the response to the query in block 150 in FIG. 2 is affirmative, in other words, the stereo parameters are already defined by the application, then a combined viewport frustum can be directly calculated in block 300.

A new origin 15 for the combined viewport frustum 150 is determined by using a midpoint of both left 10 and right 20 eyes and moving virtually backwards along the central axis 55 to a new baseline 60 where the edges of the new combined viewport frustum 150 approximately coincide with the left edge of the original left viewport frustum 100 with respect to the left eye 10 and the right edge of the original right viewport frustum 200 with respect to the right eye 20.

The combined viewport frustum 150 of the present invention is thus larger than either the left viewport frustum 100 or the right viewport frustum 200. Consequently, the number of polygons to be processed for rendering when using the combined viewport frustum 150 is increased. Nevertheless, using the combined viewport frustum 150 is still more efficient than performing the viewport frustum clipping and culling twice, in other words, once for each of the two viewport frustums 100, 200.

In an optimization method according to the present invention, the frustum face clipping and the back face culling are performed as a single operation by using the combined viewport frustum 150 as shown in FIG. 1.

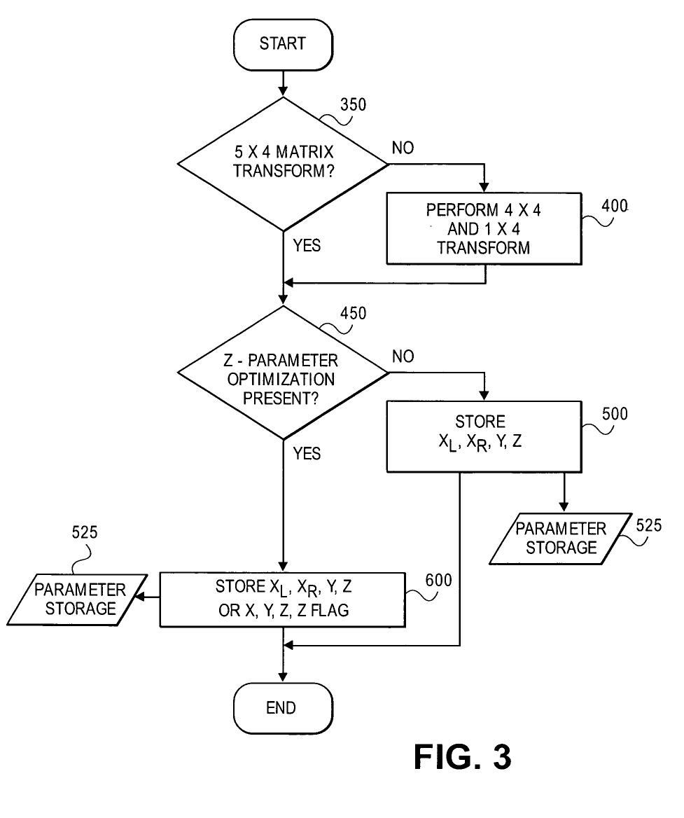

After the combined view frustum 150 is calculated, a query is made as shown in block 350 of FIG. 3 as to whether a 5×4 matrix transform has been performed. If the response is negative, then a 4×4 and a 1×4 transform are performed.

Next, a query is made as shown in block 450 of FIG. 3 as to whether Z-parameter optimization is present. If the response is negative, then X_{L}, X_{R}, Y, Z are stored as shown in block 500 to parameter storage block 525. However, if the response is affirmative, then X_{L}, X_{R}, Y, Z, or X, Y, Z, Z flag are stored as shown in block 600 to parameter storage block 525.

Hidden surface removal (HSR) is performed by processing data from an internal Z parameter buffer. Visibility is resolved independently by comparing Z values of vertices in 3D space. Interpolation is done as needed. Polygons are processed in an arbitrary order. The Z parameter buffer can also handle interpenetration and overlapping of polygons.

In an optimization method according to the present invention, when rendering polygons that are shared between both left 10 and right 20 eye views, calculations for the hidden surface removal are performed only once for both views rather than once for each view. Tagging the transformed geometry during the clip/cull operation allows such an optimization.

In another optimization method according to the present invention, the polygons that are visible to only one eye do not need hidden surface removal processing for the other eye.

In order to minimize bandwidth, the typical vertex data structure is modified in several ways, depending on which type of 3D rendering processing is possible. Typically, X, Y, Z coordinates are represented in the data structure for the vertex data. In the case of a data structure specific to rendering of 3D left/right views, an additional element is added to the data structure for representation of the required two X-coordinates: one from the left eye 10 projection and one from the right eye 20 projection. Storing these two X-coordinates in adjacent memory results in more efficient data retrieval and caching of data structures when the 3D rendering is optimized as described in the next section.

In addition to the vertex data representation, some 3D rendering algorithms will store additional parameters or pointers related to the geometry for subsequent 3D rendering operations. These data structures are also optimized to the left eye 10 and right eye 20 rendering. A pointer to a vertex contains information linking to other vertices in the same object or linking to other vertices from different objects that share screen locality. These structures also contain information regarding whether the vertices are visible to the left eye viewport 100 only, the right eye viewport 200 only, or to both eye viewports 100, 200.

Depending on the viewing distance 125, 225 and a normal angle to the origin of the combined viewport frustum 150, polygons located on the edge of objects are visible to only one eye. In an optimization method according to the present invention, the relevant vertices comprising these polygons beyond a maximum edge render distance 300 as shown in FIG. 1 are identified for rendering only during generation of either the left 10 or right 20 eye view.

In addition, if the Z parameter distance is greater than the maximum edge render distance 300 as shown in FIG. 1, these edge effects are irrelevant and a normal test as a function of viewing distance 125, 225 is eliminated. The maximum edge render distance 300 is a function of vernier visual acuity as well as the display resolution and viewing distance 125, 225. A safe calculation would be to base the maximum edge render distance 300 only on the convergence distance 5.

Pixel texturing is performed next. Texture mapping includes a process of applying a 2D image to a surface of a polygon. Texture pixels are also known as texels. The size of a texel usually does not match a size of the corresponding pixel. A filtering method may be needed to map the texels to the pixels, The filtering may include a weighted linear average of 2×2 array of texels that lie nearest to the center of the pixel is used. The filtering may also include linear interpolation between 2 nearest texels.

A pair of texture coordinates is assigned to each vertex of a 3D object. The texture coordinate assignment may be automatically assigned by the API, explicitly set per vertex by a developer, or explicitly set via mapping rules by the developer. Texture coordinates may be calculated per-frame and per-vertex. The texture coordinates are modified through scaling, rotation, and translation.

In another embodiment of the present invention, pixel processing for the left eye 10 view and the right eye 20 view are integrated. For rendering of the left and right eye views, the textures are transformed in a similar way to the geometry. The left and right eye views only differ in the X dimension of the textures in the horizontal direction.

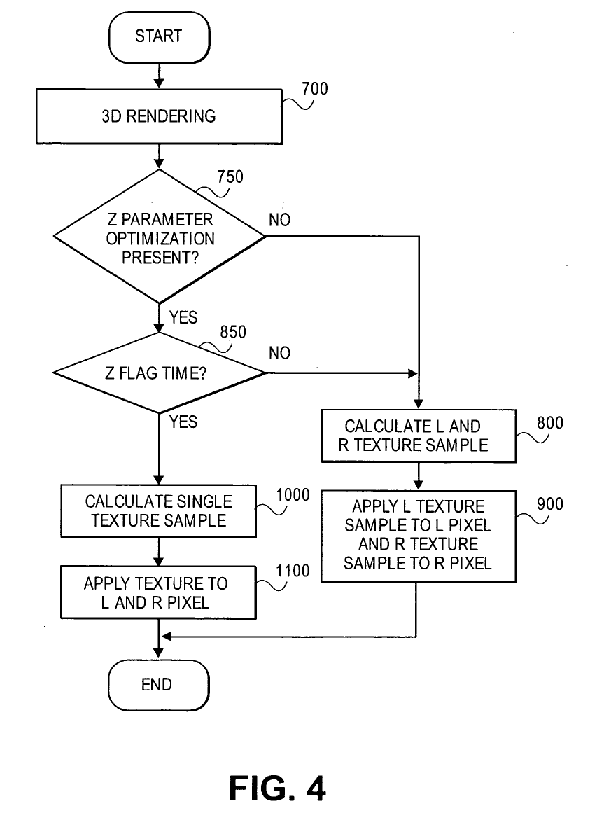

As shown in block 750 in FIG. 4, a query is made as to whether Z parameter optimization is present.

If the response is in the negative, then left and right texture sample are calculated as shown in block 800. Then the left texture sample is applied to the left pixel while the right texture sample is applied to the right pixel as shown in block 900.

If the response is affirmative, then a query is made as shown in block 850 as to whether z flag time is set.

If the response is in the negative, then left and right texture sample are also calculated as shown in block 800. Then the left texture sample is also applied to the left pixel while the right texture sample is also applied to the right pixel as shown in block 900.

If the response is affirmative, then a single texture sample is calculated as shown in block 1000. Then the texture is applied to both left and right pixels as shown in block 1100.

Similar to geometry processing, texturing is also subject to the same maximum disparity difference 400. Therefore, the optimization of using the same left and right X values is applicable to the address transformation for textures just as for the geometry transformation.

A separate texture sample for the left and right pixels is also not necessary for pixels beyond the maximum disparity distance 400.

Pixel lighting, accumulation, and alpha blend are done next. A stencil test determines whether to eliminate a pixel from a fragment when it is drawn. Lighting for a surface is pre-computed and stored in a texture map. The light map may be pre-blended with a surface texture before application to a polygonal surface. Lighting and texture mapping help to increase perceived realism of a scene by providing additional 3D depth cues.

The most important depth cues include interposition, shading, and size. Interposition refers to an object being considered to be nearer because it occludes another object. Shading refers to a shape being deduced from an interplay of light and shadows on a surface. Size refers to an object being considered to be closer because it is larger.

Other depth cues may be used. Linear perspective refers to two lines being considered to be parallel if they converge to a single point. Surface texture gradient refers to an object being considered to be closer because it shows more detail. Height in a visual field refers to an object being considered to be farther away when it is located higher (vertically) in the visual field. Atmospheric effect refers to an object being considered to be farther away because it appears blurrier. Brightness refers to an object being considered to be farther away because it appears dimmer.

Motion depth cue may be used in a sequence of images, such as in a video stream. Motion parallax refers to an object being considered to be nearer when it moves a greater distance (lateral disparity) across a field of view over a certain period of time.

Although many operations performed in the setup for pixel processing are optimized for generation of left/right eye views, the pixels themselves must be actually computed and generated. An exception is when the distance is greater than the maximum disparity distance 400. For objects in this range, only one pixel value computation is performed which will be stored to both the left and right eye views.

The pixels are processed in a particular order so as to take full advantage of a natural redundancy in the left and right eye views. Optimizations for texture address generation, texture sample values, and for pixel values will permit a reduction of intermediate data stored in internal cache and thus increase efficiency if the processing is more coherent.

Various levels of coherency are available. A highest level having the least coherency advantage will alternate left and right eye rendering on an area basis, such as in 32×32 pixel zones. A more efficient level will alternate between left and right pixels in subsequent clock cycles across parallel compute pipelines. An even more efficient level will include processing left and right concurrently across parallel compute pipelines, such as a 4-pipe design in which pipes 1 and 3 process left pixels while pipes 2 and 4 process right pixels.

Pixel formatting, or view combining, is performed in a back buffer.

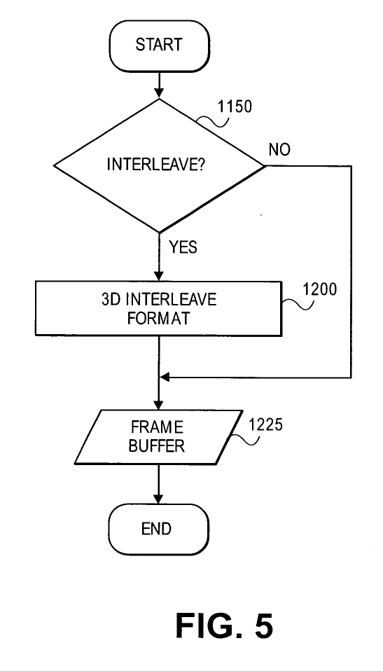

As shown in block 1150 of FIG. 5, a query is made as to whether to interleave. If the response is negative, then the data are stored to the left and right eye view frame buffers 1225. However, if the response is affirmative, a 3D-interleave format is used first as shown in block 1200 before also storing the data to the frame buffer 1225.

Depending on a particular 3D stereoscopic display rendering technique, the left and right pixel data may be interleaved at various levels, such as at a subpixel level, a full-color pixel level, a horizontal-line level, or at a frame level.

Upon completion, the data are flipped to a front buffer. The display is refreshed as needed. The display surface is located a certain distance from the eyes of the viewer.

Many embodiments and numerous details have been set forth above in order to provide a thorough understanding of the present invention. One skilled in the art will appreciate that many of the features in one embodiment are equally applicable to other embodiments. One skilled in the art will also appreciate the ability to make various equivalent substitutions for those specific materials, processes, dimensions, concentrations, etc. described herein. It is to be understood that the detailed description of the present invention should be taken as illustrative and not limiting, wherein the scope of the present invention should be determined by the claims that follow.

We claim:

1. A method of optimizing a generation of a stereoscopic scene comprising:
calculating an X separation distance between vertices transformed for a left eye and a right eye, said X separation distance corresponding to an interpupilary distance in a horizontal direction; and
transforming geometry only once from orthogonal world space coordinates to perspective-corrected view for both said left eye and said right eye.

2. The method of claim 1 wherein said X separation distance is calculated by performing an additional vector calculation.

3. The method of claim 1 wherein said X separation distance is calculated by performing a 5×4 matrix transform.

4. The method of claim 1 wherein a Z parameter is not beyond a maximum disparity distance, said maximum disparity distance being a function of vernier, visual acuity and resolution as well as viewing distance from said left eye and said right eye to a display.

5. The method of claim 1 wherein orthogonal world coordinate input data are already in a computation pipeline so said data do not have to be re-read from an external memory or a local cache.

6. A method of optimizing a generation of a stereoscopic scene comprising:
calculating a combined viewport frustum from a left viewport frustum and a right viewport frustum;
performing frustum face clipping based on said combined viewport frustum; and
performing back face culling based on said combined viewport frustum.

7. The Method of claim 6 wherein a Z parameter is not beyond a maximum edge render distance, said maximum edge render distance being a function of vernier visual acuity and resolution as well as viewing distance from said left eye and said right eye to a display.

8. A method of 3D rendering of pixels comprising:
performing hidden surface removal once for polygons that are shared between left eye viewport and right eye viewport; and
performing hidden surface removal once for polygons that are visible to only one of the two eye viewports.

9. The method of claim 8 wherein vertex data structures are tagged during clip/cull operation to provide information regarding whether each vertex is visible to said left eye viewport, said right eye viewport, or to both eye viewports.

10. A method of optimizing texturing for 3D rendering of pixels comprising:
calculating an X separation distance between vertices transformed for a left eye and a right eye, said X separation distance corresponding to an interpupilary distance in a horizontal direction; and
transforming texturing only once for both said left eye and said right eye.

11. The method of claim 1 wherein said X separation distance is calculated by performing an additional vector calculation.

12. The method of claim 1 wherein said X separation distance is calculated by performing a 5×4 matrix transform.

13. The method of claim 1 wherein Z parameter is not beyond a maximum disparity distance, said maximum disparity distance being a function of grating, or vernier, visual acuity and resolution as well as viewing distance from said left eye and said right eye to a display.

14. The method of claim 1 wherein orthogonal world coordinate input data are already in a computation pipeline so said data do not have to be re-read from an external memory or a local cache.

15. A method of taking advantage of redundancy and coherency in left and right eye views comprising:
optimizing texture address generation;
optimizing texture sample values; and
optimizing pixel values.

16. The method of claim 15 wherein 3D rendering of pixels in said left eye views and said right eye views are alternated on an area basis.

17. The method of claim 15 wherein 3D rendering of said left eye views and said right eye views is alternated between left and right pixels in subsequent clock cycles across parallel compute pipelines.

18. The method of claim 15 wherein 3D rendering of pixels in said left eye views and said right eye views are processed simultaneously across parallel compute pipelines.

19. A method of improving efficiency of stereoscopic visualization by reducing intermediate data stored in internal cache comprising: storing 2 parameters of X-coordinates (horizontal components) instead of storing 2 sets of full 3 dimensions (for separate left and right eye views).

20. The method of claim 19 comprising: calculating the 2 parameters of X-coordinates (horizontal components) at the same time so that orthogonal world coordinate input data required for both calculations are already in a computation pipeline and thus said data do not have to be re-read from either an external memory or a local cache.
